(19) United States
(12) Patent Application Publication
(10) Pub. No.: US 2023/0026385 A1
(43) Pub. Date: Jan. 26, 2023

(54) SYSTEM AND COGNITIVE METHOD FOR THREAT MODELING

(71) Applicant: International Business Machines Corporation, Armonk, NY (US)

(72) Inventors: Li Bo Zhang, Beijing (CN); Zhe Yan, Beijing (CN); Rong Zhao, Beijing (CN); Li Li Guan, Beijing (CN); Hao Jia Li, Beijing (CN)

(21) Appl. No.: 17/381,670

(22) Filed: Jul. 21, 2021

(51) Int. Cl. G06F 21/57; G06N 20/00

(52) U.S. Cl. CPC G06F 21/577; G06N 20/00; G06F 2221/034

(57) ABSTRACT

Using machine learning to help identify and assess threats in an information technology (IT) computing environment. Machine learning type training is used to train both a threat model and a set of data model(s).

### BACKGROUND

The present invention relates generally to the field of cognitive methods and also to the field of threat modeling of many different industries, such as IT (information technology) industry threats.

The Wikipedia entry for “cognitive model” (as of May 11, 2020) states as follows: “A cognitive model is an approximation to animal cognitive processes (predominantly human) for the purposes of comprehension and prediction. There are many types of cognitive models, and they can range from box-and-arrow diagrams to a set of equations to software programs that interact with the same tools that humans use to complete tasks (e.g., computer mouse and keyboard). Relationship to cognitive architectures. Cognitive models can be developed within or without a cognitive architecture, though the two are not always easily distinguishable. In contrast to cognitive architectures, cognitive models tend to be focused on a single cognitive phenomenon or process (e.g., list learning), how two or more processes interact (e.g., visual search bsc1780 decision making), or making behavioral predictions for a specific task or tool (e.g., how instituting a new software package will affect productivity). Cognitive architectures tend to be focused on the structural properties of the modeled system, and help constrain the development of cognitive models within the architecture. Likewise, model development helps to inform limitations and shortcomings of the architecture. Some of the most popular architectures for cognitive modeling include ACT-R, Clarion, LIDA, and Soar.” (footnote(s) omitted)

The Wikipedia entry for “threat model” (as of May 11, 2020) states as follows: “Threat modeling is a process by which potential threats, such as structural vulnerabilities or the absence of appropriate safeguards, can be identified, enumerated, and mitigations can be prioritized. The purpose of threat modeling is to provide defenders with a systematic analysis of what controls or defenses need to be included, given the nature of the system, the probable attacker’s profile, the most likely attack vectors, and the assets most desired by an attacker. Threat modeling answers questions like ‘Where am I most vulnerable to attack?’, ‘What are the most relevant threats?’, and ‘What do I need to do to safeguard against these threats?’. Conceptually, most people incorporate some form of threat modeling in their daily life and don’t even realize it. Commuters use threat modeling to consider what might go wrong during the morning drive to work and to take preemptive action to avoid possible accidents. Children engage in threat modeling when determining the best path toward an intended goal while avoiding the playground bully. In a more formal sense, threat modeling has been used to prioritize military defensive preparations since antiquity. Threat modeling methodologies for IT purposes. Conceptually, a threat modeling practice flows from a methodology. Numerous threat modeling methodologies are available for implementation. Typically, threat modeling has been implemented using one of four approaches independently, asset-centric, attacker-centric, and software-centric. Based on volume of published online content, the methodologies discussed below are the most well known.”

### SUMMARY

According to an aspect of the present invention, there is a method, computer program product and/or system that performs the following operations (not necessarily in the following order): (i) receiving a threat model based on an initial threat assessment; (ii) training the threat model using historical data related to historical instances of threats and/or historical instances of corrective action(s) taken to address historical instances of threats to obtain a trained threat model; (iii) receiving a set of data model(s); (iv) training the set of data models by machine learning techniques and historical data to obtain a set of trained data model(s); (v) receiving an input data set reflecting operations and/or communications in an information technology (IT) computing environment; and (vi) applying the trained threat model and the set of trained data model(s) to the input data set to determine that a potential threat condition exists in the IT computing environment.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system; and

FIG. 3 is a block diagram showing a machine logic (for example, software) portion of the first embodiment system.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer’s non-volatile storage and partially stored in a set of semiconductor switches in the computer’s volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

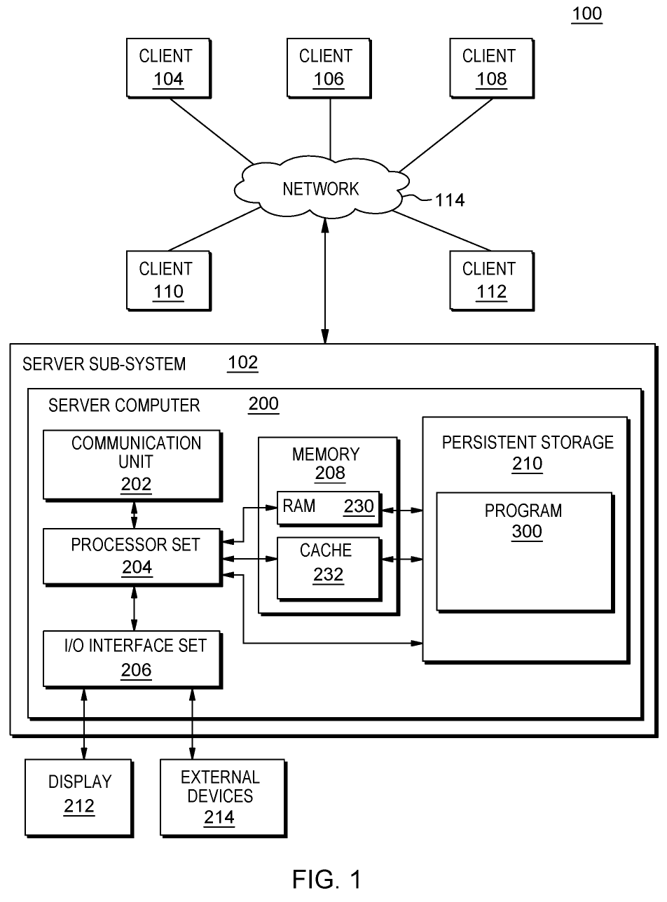

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

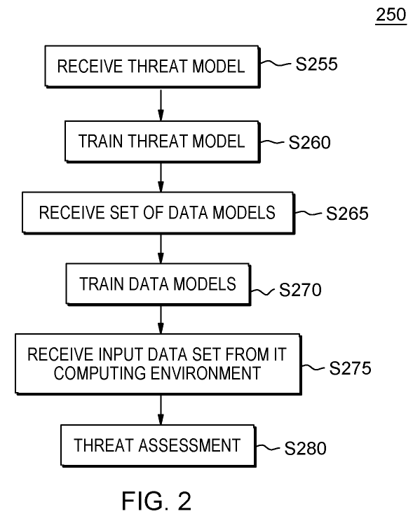

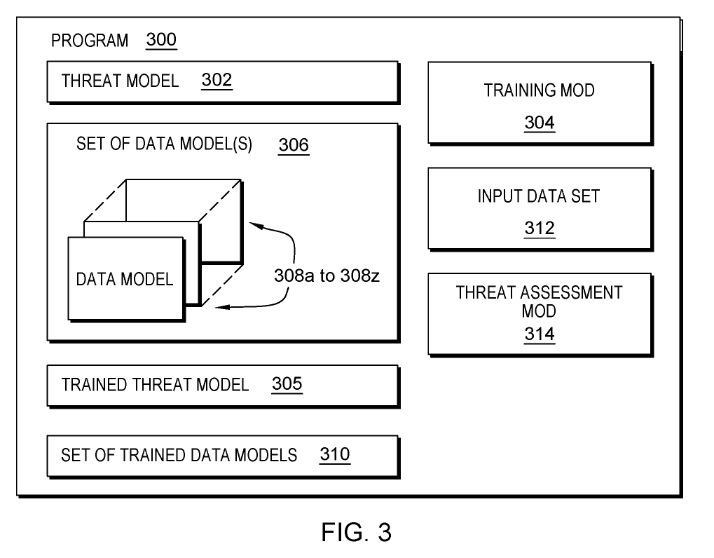

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation S255, where program 300 receives threat model 302. In this example, threat model 302 was created by client subsystem 104 based on an initial threat assessment, and then sent to server subsystem 102 through network 114.

Processing proceeds to operation S260, where training module (“mod”) 304 trains threat model 302 using historical data related to historical instances of threats and/or historical instances of corrective action(s) taken to address historical instances of threats to obtain a trained threat model 305.

Processing begins at operation S265, where program 300 receives set of data model(s) 306 including data models 308a to 308z. In this example, the data models were created by client subsystem 106, and then sent to server subsystem 102 through network 114.

Processing proceeds to operation S270, where training mod 304 trains the set of data models by machine learning techniques and historical data to obtain a set of trained data model(s) 310.

Processing proceeds to operation S275, where program 300 receives input data set 312 reflecting operations and/or communications in an information technology (IT) computing environment. In this example, the IT computing environment being monitored for threats is made up of client subsystems 108, 110 and 112 (and the dedicated portions of network 114 that connects these subsystems in data communication).

Processing proceeds to operation S280, where threat assessment mod 314 applies the trained threat model and the set of trained data model(s) to the input data set to determine that a potential threat condition exists in the IT computing environment.

### III. Further Comments and/or Embodiments

Some embodiments of the present invention may recognize the following problems and/or opportunities for improvement: (i) every industry performs risk assessment (such as finance, government, internet, venture capital, etc.); (ii) includes using existing tools and methods to perform risk assessment following industry standard; (iii) at the earliest phase of the software development life cycle (SDLC), the project architect team and security teams focus and work together on threat modeling (using the IT (information technology) industry as an example); (iv) currently most projects are delivered in: (a) continuous delivery mode, and/or (b) continuous integration mode; (v) it is correct and efficient to complete the baseline version threat model at the earliest phase of SDLC to meet security release requirements; (vi) enables the architect to be aware of the security requirements; and/or (vii) there is no quick path to perform threat assessment based on design input and existing knowledge.

Some embodiments of the present invention recognize the following facts, potential problems and/or potential areas for improvement with respect to the current state of the art: (i) threat modeling is frequently used in many industries such as government, hospitals, banking and IT (information technology); (ii) most projects are delivered in CICD (combined practices of continuous integration and continuous deployment) mode (for example, the IT industry); (iii) it is considered correct and efficient to complete the baseline version of the threat model at an earlier phase of SDLC to meet security release requirements; (iv) the architect is aware of the security requirements at the design phase of SDLC; and/or (v) there is no quick path to perform threat assessment based on design input and existing knowledge.

Some embodiments of the present invention may include one, or more, of the following operations, features, characteristics and/or advantages: (i) performs threat assessment and creates a threat model at the earliest phase of the software development life cycle; (ii) uses historical data to create data models; (iii) trains machine learning models (that is, the data models and/or threat model); (iv) performs threat assessment logic mining; (v) automatically makes improvements to the governing rules by considering new data as it is received by the machine learning system; (vi) identifies threats; (vii) adds threat assessment records with predicted weakness; and/or (viii) adds mitigation plans using AI (artificial intelligence) technologies.

Some embodiments of the present invention may include one, or more, of the following operations, features, characteristics and/or advantages when there is new input: (i) uses a history artifacts pool as a data source for data abstraction and analysis; (ii) uses three data models built with industry logic to enable the system where more accurate central points are used to: (a) improve algorithm accuracy, and (b) use more effective sample points to increase algorithm convergence speed; (iii) uses a machine learning model to identify threat weakness categories; (iv) performs threat assessment; and/or (v) provides threat description and threat mitigation plans.

According to some embodiments of the present invention, the following five (5) threat models are used: (i) threat modeling sources analyzer: identifies entities in the threat model document that might contain a weakness; (ii) threat indicator data model cluster: based on component inventory, interface inventory, credential inventory, etc., trains a model which can identify the threat input factor; (iii) data flow data model cluster: based on the same architecture threat assessment sheets, trains a model which identifies threats arising from data flow operations; (iv) weakness category data model cluster: (a) threat description and recommend mitigation, that are similar, will be clustered, and/or (b) best threat description and recommended mitigation will be marked as central points (baseline); and/or (v) machine learning model for prediction, weakness, and mitigation recommendation: (a) for all the identified threat description and recommend mitigation, trains a machine learning model to predict its cluster, based on the baseline, and/or (b) whenever there is a new project design as input, display the best match threat description and recommend mitigation in that cluster to the architect.

Some embodiments of the present invention may include one, or more, of the following operations, features, characteristics and/or advantages (i) is used in the very early design phase (or earlier phase of many other industries, such as such as finance, government, internet, venture capital, etc.); (ii) is not limited to the IT industry; (iii) input includes design logic flow, a design logic data dictionary, data flow design, etc.; and/or (iv) more specifically, is used in the early design phase / threat modeling phase, which is related to the architect’s role and the development senior leader role, to perform product threat analysis, and then use the analysis result as input to improve the architectural design to mitigate security issues.

Some embodiments of the present invention may include one, or more, of the following operations, features, characteristics and/or advantages: (i) does a lot of work even before any model training starts including: (a) improving data abstraction efficiency through preanalysis from a specific data model, (b) insures extract threat related feature efficiently through logical matrix enhancement, and/or (c) increases function convergence speed and accuracy through feature extraction and weighting; (ii) during machine learning mode training, enhances the algorithm by applying more accurate central points of the algorithm to improve the algorithm accuracy; (iii) provides more effective sample points to increase the algorithm convergence speed; and/or (iv) aims to: (a) cognitively perform industry threat modeling at earlier phases of the industry production lifecycle, (b) provide weakness prediction, and/or (c) provide mitigation plan recommendation(s).

Some embodiments of the present invention may include one, or more, of the following operations, features, characteristics and/or advantages: (i) creates a Risk Model which results in more happening in the very early design phase; (ii) creates data models and machine learning models from zero; (iii) does not need explicit input data; (iv) is not relegated to every software development lifecycle phase; (v) does not have any task list; (vi) is not related to release gating; (vii) creates data models and machine learning models; (viii) output is cognitively performed using industry threat modeling at earlier phases of the industry production lifecycle; and/or (ix) provides weakness prediction and mitigation plan recommendation.

Some embodiments of the present invention may include one, or more, of the following operations, features, characteristics and/or advantages: (i) creates one or more data models with industry logic built-in for enabling the system to use more accurate central points to improve algorithm accuracy; (ii) uses more effective sample points to increase algorithm convergence speed wherein the data models can be: (a) a threat to the modeling sources analyzer, (b) a threat to the indicator data model cluster, (c) a data flow data model cluster, and/or (d) a weakness category data model cluster; and/or (iii) aims to: (a) identify threat weakness categories, (b) performs threat assessment, and/or (c) provides threat description and threat mitigation plans by utilizing a machine learning model.

Some embodiments of the present invention may include one, or more, of the following operations, features, characteristics and/or advantages: (i) includes a system and cognitive method to identify: (a) the threat weakness category, (b) provide threat description, and/or (c) provide threat mitigation information whenever there is new input by: (1) providing a history of threat inventories, (2) providing an assessment artifacts pool as a data source for analysis, (3) providing an input factor model trained as a trigger of a weakness, (4) providing a description and mitigation model trained to recommend project architects to take actions to mitigate weakness, (5) providing a weakness category cluster model to group similar weaknesses, and/or (6) generates the most accurate mitigation recommendations; and/or (ii) includes a machine learning prediction model to identify the best matching mitigation recommendation.

Some embodiments of the present invention may include one, or more, of the following operations, features, characteristics and/or advantages: (i) creates a risk model where more happens in the very early design phase of many possible industries; (ii) creates data models and machine learning models from zero; (iii) does a lot of work even before any model training starts including: (a) improves data abstraction efficiency, and/or (b) insures the extract threat related feature is done efficiently; (iv) increases function convergence speed and accuracy; (v) during machine learning mode training, enhances the algorithm by applying more accurate central points of the algorithm to improve algorithm accuracy; and/or (vi) adds more effective sample points to increase algorithm convergence speed.

Some embodiments of the present invention may include one, or more, of the following operations, features, characteristics and/or advantages: (i) begins at an earlier phase of the software development life cycle; (ii) uses a system and a cognitive method to create data models; (iii) trains machine learning models; (iv) identifies threats; (v) adds threat assessment records with predicted weakness; and/or (vi) adds a mitigation plan using AI technologies whenever there is new input.

Some embodiments of the present invention may include one, or more, of the following operations, features, characteristics and/or advantages: (i) cognitively and continuously learns new threat mitigations from new designs of each projects threat assessment document(s); (ii) presents best-match threat mitigations of the latest weakness categories; and/or (iii) keeps updating with the same design language and the same design templates.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above ― similar cautions apply to the term “embodiment.”

and/or: inclusive or; for example, A, B “and/or” C means that at least one of A or B or C is true and applicable.

Including / include / includes: unless otherwise explicitly noted, means “including but not necessarily limited to.”

Module / Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a threat model based on an initial threat assessment;
training the threat model using historical data related to historical instances of threats and/or historical instances of corrective action(s) taken to address historical instances of threats to obtain a trained threat model;
receiving a set of data model(s);
training the set of data models by machine learning techniques and historical data to obtain a set of trained data model(s);
receiving an input data set reflecting operations and/or communications in an information technology (IT) computing environment; and
applying the trained threat model and the set of trained data model(s) to the input data set to determine that a potential threat condition exists in the IT computing environment.

2. The CIM of claim 1 further comprising:
outputting a communication including information indicative of the potential threat condition; and
responsive to the determination of the potential threat condition, automatically providing a mitigation recommendation.

3. The CIM of claim 1 wherein the training of the threat model includes:
performing threat assessment logic mining.

4. The CIM of claim 3 wherein the training of the threat model further includes:
adding threat assessment records with predicted weakness.

5. The CIM of claim 1 further comprising:
adding mitigation plans using AI (artificial intelligence) technologies.

6. The CIM of claim 1 further comprising:
performing data abstraction using history artifacts pool as a data source; and
performing data analysis using history artifacts pool as a data source.

7. A computer program product (CPP) comprising:
a set of storage device(s); and
computer code stored collectively in the set of storage device(s), with the computer code including data and instructions to cause a processor(s) set to perform at least the following operations:
receiving a threat model based on an initial threat assessment,
training the threat model using historical data related to historical instances of threats and/or historical instances of corrective action(s) taken to address historical instances of threats to obtain a trained threat model,
receiving a set of data model(s),
training the set of data models by machine learning techniques and historical data
to obtain a set of trained data model(s),
receiving an input data set reflecting operations and/or communications in an information technology (IT) computing environment, and
applying the trained threat model and the set of trained data model(s) to the input data set to determine that a potential threat condition exists in the IT computing environment.

8. The CPP of claim 7 wherein the computer code further includes instructions for causing the processor(s) set to perform the following operation(s):
outputting a communication including information indicative of the potential threat condition; and
responsive to the determination of the potential threat condition, automatically providing a mitigation recommendation.

9. The CPP of claim 7 wherein the training of the threat model includes:
performing threat assessment logic mining.

10. The CPP of claim 9 wherein the training of the threat model further includes:
adding threat assessment records with predicted weakness.

11. The CPP of claim 7 wherein the computer code further includes instructions for causing the processor(s) set to perform the following operation(s):
adding mitigation plans using AI (artificial intelligence) technologies.

12. The CPP of claim 7 wherein the computer code further includes instructions for causing the processor(s) set to perform the following operation(s):
performing data abstraction using history artifacts pool as a data source; and
performing data analysis using history artifacts pool as a data source.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving a threat model based on an initial threat assessment,
training the threat model using historical data related to historical instances of threats and/or historical instances of corrective action(s) taken to address historical instances of threats to obtain a trained threat model,
receiving a set of data model(s),
training the set of data models by machine learning techniques and historical data
to obtain a set of trained data model(s),
receiving an input data set reflecting operations and/or communications in an information technology (IT) computing environment, and
applying the trained threat model and the set of trained data model(s) to the input data set to determine that a potential threat condition exists in the IT computing environment.

14. The CS of claim 13 wherein the computer code further includes instructions for causing the processor(s) set to perform the following operation(s):
outputting a communication including information indicative of the potential threat condition; and
responsive to the determination of the potential threat condition, automatically providing a mitigation recommendation.

15. The CS of claim 13 wherein the training of the threat model includes:
performing threat assessment logic mining.

16. The CS of claim 15 wherein the training of the threat model further includes:
adding threat assessment records with predicted weakness.

17. The CS of claim 13 wherein the computer code further includes instructions for causing the processor(s) set to perform the following operation(s):
adding mitigation plans using AI (artificial intelligence) technologies.

18. The CS of claim 13 wherein the computer code further includes instructions for causing the processor(s) set to perform the following operation(s):
performing data abstraction using history artifacts pool as a data source; and
performing data analysis using history artifacts pool as a data source.
